(19) United States
(12) Patent Application Publication
(10) Pub. No.: US 2012/0189916 A1
(43) Pub. Date: Jul. 26, 2012

(54) NON-AQUEOUS ELECTROLYTE SECONDARY BATTERY

(75) Inventors: Naoki Imachi, Kobe-shi (JP); Takanobu Chiga, Kobe-shi (JP)

(73) Assignee: SANYO ELECTRIC CO., LTD., Osaka (JP)

(21) Appl. No.: 13/357,817

(22) Filed: Jan. 25, 2012

(30) Foreign Application Priority Data
Jan. 26, 2011 (JP) 2011-013699

(51) Int. Cl. H01M 2/16

(52) U.S. Cl. 429/246

(57) ABSTRACT

A non-aqueous electrolyte secondary battery has a positive electrode containing a positive electrode active material, a negative electrode containing a negative electrode active material, a non-aqueous electrolyte, a separator interposed between the positive electrode and the negative electrode, and a porous layer provided on a surface of the positive electrode. The porous layer contains titania particles, a dispersing agent, and an aqueous binder. The dispersing agent includes silica having an average particle size of less than 100 nm and less than that of the titania particles.

### BACKGROUND OF THE INVENTION

1. Field of the Invention

The present invention relates to non-aqueous electrolyte secondary batteries.

2. Description of Related Art

Rapid advancements in size and weight reductions of mobile information terminal devices such as mobile telephones, notebook computers, and PDAs in recent years have created demands for higher capacity batteries as the drive power source for such devices. Moreover, the mobile information terminal devices tend to consume more and more power, as the functions of the devices, such as video playing functions and gaming functions, become more complex and diverse. Consequently, it is strongly desired that lithium-ion batteries that are the driving power source for the devices have further higher capacities and higher performance in order to achieve longer battery life and improved output power.

Various techniques have been studied for increasing the capacity of the lithium-ion batteries, including improvements in electrode structure such as increasing the amount of the active material contained and increasing the filling density, as well as employment of alloy-based negative electrode containing, for example, Si or Sn. Viewed from the aspect of the material, development has been directed toward increasing the charge voltage of the positive electrode active material. Accordingly, there is an urgent need for the techniques for preventing oxidation of the electrolyte and controlling activation of the positive electrode active material when charging the positive electrode active material at high voltage. As the solution to these problems, several elemental techniques have been developed, including the technique of fluorinating part of electrolyte to prevent oxidation of the electrolyte and the technique of surface treating the positive electrode active material to control activation of the positive electrode active material. One of the examples is the technique of forming a porous layer made of inorganic particles (titanium oxide) on the positive electrode surface to improve the battery performance under high voltage and high temperature conditions, which is proposed in WO 2007/108425.

Similarly, Japanese Published Unexamined Patent Application Nos. 2009-302009 and 2010-192127 propose the technique of forming a porous layer containing inorganic particles (alumina, titania, zirconia, or magnesia) on the positive electrode to improve the performance at high temperatures. It has been proposed to use an aqueous slurry as a method of forming the porous layer.

Furthermore, WO 2005/029614 proposes the technique of forming a porous layer containing inorganic particles on the negative electrode using an organic solvent-based slurry to improve the insulation performance and to thereby improve the battery safety. In addition, Japanese Published Unexamined Patent Application No. 2009-070797 proposes the technique of forming a porous layer on the surface of one of the positive and negative electrodes and controlling the pores by allowing the porous layer to contain two kinds of inorganic compounds having different particle shapes, to thereby improve the electrolyte permeation of the electrolyte solution and enhance the battery performance at high temperatures.

As described above, various techniques have been proposed of forming a porous layer comprising inorganic particles on the surface of one of the positive and negative electrodes. When the porous layer is formed on the positive electrode surface, an aqueous slurry is used. One of the reasons is that an organic solvent-based slurry is commonly used for forming the positive electrode active material layer. That is, if, for example, PVDF is used as the binder when forming the porous layer on the positive electrode surface, it is necessary to use an organic solvent, such as NMP, as the solvent. However, using an organic solvent for the slurry for forming the porous layer means that the solvent used is similar to that used for forming the positive electrode active material layer. As a consequence, when applying the slurry for forming the porous layer to the positive electrode surface, it is likely that the organic solvent and the binder diffuse into the positive electrode active material layer, causing the binder existing in the positive electrode active material layer to swell. This causes a decrease of the energy density and also leads to unevenness in the distribution of PVDF, and consequently, it is possible that the electrochemical reaction may become non-uniform.

In view of such problems, aqueous slurry is used when the porous layer is formed on the surface of the positive electrode active material layer.

Nevertheless, the use of water for the slurry for forming the porous layer is problematic in terms of dispersion stability of the inorganic particles. To solve this problem, the above-described references use organic additives (CMC, polyacrylic acid, glycol-based materials, etc.), which has high capability of stabilizing the dispersion of the inorganic particles. However, since the inorganic particle layer is in contact with the surface of the positive electrode active material layer, the organic additive is exposed to a strong oxidizing atmosphere under the catalytic activity of the positive electrode active material at a high potential. As a consequence, the side reaction of decomposition of the organic additive occurs, which causes adverse effects on the battery. Moreover, the use of CMC, for example, as the dispersing agent causes another problem as follows. Because CMC has low affinity with the electrolyte solution, the affinity between the positive electrode active material layer and the electrolyte solution lowers. Consequently, the electrolyte balance in the battery is disturbed. Accordingly, in order to further improve the battery performance, it is necessary to develop an addition agent (dispersing agent) that can inhibit the adverse effects on the battery resulting from the side reactions while maintaining the dispersion stability of the inorganic particles.

### BRIEF SUMMARY OF THE INVENTION

The present invention provides a non-aqueous electrolyte secondary battery comprising: a positive electrode containing a positive electrode active material; a porous layer, provided on a surface of the positive electrode, comprising inorganic particles, a dispersing agent, and an aqueous binder, the dispersing agent comprising silica having an average particle size of less than 100 nm and less than that of the inorganic particles; a negative electrode containing a negative electrode active material; a separator interposed between the positive electrode and the negative electrode; and a non-aqueous electrolyte containing a solvent and a solute.

The present invention makes it possible to improve the dispersion stability of the inorganic particles and at the same time improve the performance at high temperatures of a non-aqueous electrolyte secondary battery.

### DETAILED DESCRIPTION OF THE INVENTION

Hereinbelow, the present invention is described in further detail. It should be construed, however, that the present invention is not limited to the following examples but various changes and modifications are possible without departing from the scope of the invention.

### EXAMPLE 1

Preparation of a battery A1 will be described in the following.

### Preparation of Positive Electrode

First, lithium cobalt oxide as the positive electrode active material, acetylene black as a carbon conductive agent, and PVDF (polyvinylidene fluoride) as a binder agent were weighed so that the mass ratio became 95:2.5:2.5, and thereafter were mixed together with a mixer using NMP as a solvent, to prepare a positive electrode mixture slurry.

Next, the resultant positive electrode mixture slurry was applied onto both sides of a positive electrode current collector made of an aluminum foil. The resultant article was then dried and calendered, whereby a positive electrode was prepared. The filling density of the positive electrode active material was set at 3.60 g/cm³.

### Formation of Porous Layer on Positive Electrode Surface

The materials used were as follows: water as the solvent, silica (SiO₂, hydrophilic fumed silica made by Nippon Aerosil Co., Ltd. under the trade name AEROSIL®50, average particle size: 40 nm, surface area: 50 m²/g, purity: 99.9% or higher) as the dispersing agent, titania (TiO₂, high-purity rutile-type titania made by Ishihara Sangyo Co., Ltd. under the trade name CR-EL, average particle size: 250 nm, surface area: 6.8 m²/g, purity: 99.9% or higher) as the inorganic particles, and SBR as aqueous binder. These materials were kneaded with a Filmics mixer made by Primix Corp. (with a stainless steel vessel) for 10 minutes, whereby an aqueous slurry a1 for forming a porous layer on the positive electrode surface was prepared. The average particle sizes of the silica and the titania were determined by a laser diffraction method. The average particle sizes of all the later-described substances (such as alumina) were also determined by the same method.

In this process, the amount of the silica was adjusted to be 10 mass % with respect to the total amount of the titania and the silica. The solid content of the inorganic particles in the aqueous slurry was set at 20 mass %, and the amount of the aqueous binder was set at 3 parts by mass per 100 parts by mass of the inorganic particles.

Next, the aqueous slurry a1 was coated on both sides of the positive electrode by gravure coating, and thereafter, water, serving as the solvent, was removed by drying. Thus, a porous layer was formed on both sides of the positive electrode. The thickness of the porous layer was set at 2 μm on each side (a total of 4 μm on both sides).

### Preparation of Negative Electrode

A carbon material (graphite) as the negative electrode active material, CMC (carboxymethylcellulose sodium) as the dispersing agent, and SBR (styrene-butadiene rubber) as the binder agent were mixed together so that the mass ratio became 98:1:1, whereby a negative electrode mixture slurry was prepared. Next, the resultant negative electrode mixture slurry was applied onto both sides of a negative electrode current collector made of a copper foil. The resultant article was then dried and calendered, whereby a negative electrode was prepared. The filling density of the negative electrode active material was set at 1.60 g/cm³.

### Preparation of Non-Aqueous Electrolyte Solution

LiPF₆ was dissolved at a concentration of 1 mole/liter into a mixed solvent of 3:7 volume ratio of ethylene carbonate (EC) and diethyl carbonate (DEC), to prepare a non-aqueous electrolyte solution.

### Construction of Battery

Lead terminals were attached to the positive electrode and the negative electrode prepared in the above-described manner, and they were spirally wound with separators interposed therebetween. These were pressed into a flat shape to prepare an electrode assembly. Next, the electrode assembly was inserted into an aluminum laminate battery case, and thereafter, the battery case was filled with the non-aqueous electrolyte solution and sealed, whereby a battery A1 was prepared. The design capacity of the battery A1 was set at 750 mAh. The battery was designed so that the end-of-charge voltage became 4.4 V and that the ratio of the negative electrode charge capacity to the positive electrode charge capacity (the initial charge capacity of the negative electrode/the initial charge capacity of the positive electrode) became 1.05. A polyethylene microporous film having an average pore diameter 0.1 μm, a film thickness of 16 μm, and a porosity of 47% was used as the separator.

### EXAMPLE 2

An aqueous slurry and a battery were prepared in the same manner as the aqueous slurry a1 and the battery A1, except that the amount of the silica with respect to the total amount of the titania and the silica (hereinafter also referred to simply as the amount of the silica) was set at 1 mass %.

The aqueous slurry and the battery prepared in this manner are hereinafter referred to as a slurry a2 and a battery A2, respectively.

### EXAMPLE 3

An aqueous slurry and a battery were prepared in the same manner as the aqueous slurry a1 and the battery A1, except that the amount of the silica was set at 5 mass %.

The aqueous slurry and the battery prepared in this manner are hereinafter referred to as a slurry a3 and a battery A3, respectively.

### EXAMPLE 4

An aqueous slurry and a battery were prepared in the same manner as the aqueous slurry a1 and the battery A1, except that the amount of the silica was set at 20 mass %.

The aqueous slurry and the battery prepared in this manner are hereinafter referred to as a slurry a4 and a battery A4, respectively.

### EXAMPLE 5

An aqueous slurry and a battery were prepared in the same manner as the aqueous slurry a1 and the battery A1, except that the dispersing agent used was hydrophilic fumed silica made by Nippon Aerosil Co., Ltd. under the trade name AEROSIL®90 (SiO₂, average particle size: 20 nm, surface area: 90 m²/g, purity: 99.9% or higher).

The aqueous slurry and the battery prepared in this manner are hereinafter referred to as a slurry a5 and a battery A5, respectively.

### EXAMPLE 6

An aqueous slurry and a battery were prepared in the same manner as the aqueous slurry a1 and the battery A1, except that the dispersing agent used was hydrophilic fumed silica made by Nippon Aerosil Co., Ltd. under the trade name AEROSIL®130 (SiO₂, average particle size: 16 nm, surface area: 130 m²/g, purity: 99.9% or higher).

The aqueous slurry and the battery prepared in this manner are hereinafter referred to as a slurry a6 and a battery A6, respectively.

### EXAMPLE 7

An aqueous slurry and a battery were prepared in the same manner as the aqueous slurry a1 and the battery A1, except that the inorganic particle material used was alumina (Al₂O₃, high-purity alumina made by Sumitomo Chemical Co., Ltd. under the trade name AKP-3000, average particle size: 500 nm, surface area: 4.6 m²/g, purity: 99.9% or higher).

The aqueous slurry and the battery prepared in this manner are hereinafter referred to as a slurry a7 and a battery A7, respectively.

### COMPARATIVE EXAMPLE 1

A battery was prepared in the same manner as the battery A1, except that the porous layer was not formed on the positive electrode surface.

The battery prepared in this manner is hereinafter referred to as a battery Z1.

### COMPARATIVE EXAMPLE 2

An aqueous slurry z2 was prepared in the same manner as the aqueous slurry a1, except that no silica as the dispersing agent was used. As will be described later, the dispersion stability was not obtained in the aqueous slurry z2, so it was impossible to form the porous layer on the positive electrode. For this reason, no battery was prepared for Comparative Example 2.

### COMPARATIVE EXAMPLE 3

An aqueous slurry and a battery were prepared in the same manner as the aqueous slurry a1 and the battery A1, except that CMC (the amount of the CMC added was 0.2 parts by mass per 100 parts by mass of the inorganic particles) was used as the dispersing agent in place of the silica.

The aqueous slurry and the battery prepared in this manner are hereinafter referred to as a slurry z3 and a battery Z3, respectively.

### COMPARATIVE EXAMPLE 4

An aqueous slurry and a battery were prepared in the same manner as the aqueous slurry a1 and the battery A1, except that the silica (the type and amount of the silica were the same as those for the aqueous slurry a1) and CMC (the amount of the CMC added was 0.2 parts by mass per 100 parts by mass of the inorganic particles) were used as the dispersing agent.

The aqueous slurry and the battery prepared in this manner are hereinafter referred to as a slurry z4 and a battery Z4, respectively.

### Experiment 1

The slurries a1 to a7 and z2 to z4 were studied for their dispersion stability. The results are shown in Table 1 below. The experiment was conducted as follows. The slurries were set aside for 3 days, and visual observation was sued to determine whether or not there was sedimentation of solid contents.

TABLE 1

| | | Average particle size and | | | |
|---|---|---|---|---|---|
| | | amount of silica | | | |
| | | Average | | | Slurry |
| | Inorganic | particle size | Amount | Addition of | dispersion |
| Slurry | particle | (nm) | (mass %) | CMC | stability |
| a1 | TiO₂ | 40 | 10 | No | Good |
| a2 | | | 1 | No | Good |
| a3 | | | 5 | No | Good |
| a4 | | | 20 | No | Good |
| a5 | | 20 | 10 | No | Good |
| a6 | | 16 | 10 | No | Good |
| a7 | Al₂O₃ | 40 | 10 | No | Good |
| z2 | TiO₂ | — | — | No | Poor |
| z3 | | — | — | Yes | Good |
| z4 | | 40 | 10 | Yes | Good |

As clearly seen from the results of the slurry dispersion stability indicated in Table 1, the slurries a1 to a7, z3, and z4, which contained at least one of the silica or the CMC, showed very high aqueous slurry dispersion stability, and no sedimentation of solid content was observed even after they were set aside for 3 days after the dispersion treatment. In contrast, the slurry z2, which contained neither silica nor CMC, showed that sedimentation of solid content occurred immediately after the dispersion treatment, and the solid content was almost completely separated 1 hour later. These results indicate that when the amount of the silica is 1 mass % or greater, the same level of the dispersion capability as obtained in the case of adding CMC can be obtained.

### Experiment 2

The batteries A1 to A7, Z1, Z3, and Z4 were charged and discharged under the following conditions to determine their high-temperature storage performance (remaining capacity ratio after storage at 60° C.) and high-rate capability (discharge rage ratio). The results also shown in Table 2 below.

### High-Temperature Storage Performance Test

For each of the batteries, the charge-discharge cycle test was conducted under the following conditions one time. Thereafter, each battery was charged under the same conditions again, and then stored at 60° C. for 5 days. Thereafter, each of the batteries was cooled to room temperature and then discharged at a constant current of 1.0 It (750 mA) or 0.2 It (150 mA) to 2.75 V. Then, the remaining capacity ratio was calculated from the following equation (1).

### Charge-Discharge Conditions

Each of the batteries was charged at a constant current of 1.0 It (750 mA) to 4.4 V and thereafter charged with a constant voltage until a current of 0.05 It (37.5 mA) was reached. Then, each battery was rested for 10 minutes and thereafter discharged at a constant current of 1.0 It (750 mA) or 0.2 It (150 mA) to 2.75 V.

### Equation for Calculating Remaining Capacity Ratio

$$Remaining capacity ratio ( \% ) = [ \frac{( \begin{matrix}Discharge capacity \\ after storage\end{matrix} ) /}{( \begin{matrix}Discharge capacity \\ before storage\end{matrix} )} ] \times 100 \qquad Eq . ( 1 )$$

### High-Rate Capability Test

Each of the batteries was subjected to the first and second charge-discharge cycles under the following conditions, and the discharge rate ratio was calculated using the following equation (2).

### Charge-Discharge Conditions for the First Cycle

Each of the batteries was charged at a constant current of 1.0 It (750 mA) to 4.4 V and thereafter charged with a constant voltage until a current of 0.05 It (37.5 mA) was reached. Then, each battery was rested for 10 minutes and thereafter discharged at a constant current of 1.0 It (750 mA) to 2.75 V.

### Charge-Discharge Conditions for the Second Cycle

Each battery was discharged under the same conditions as the first-time charge and discharge except that the discharge current was set at 3.0 It (2250 mA).

### Equation for Calculating Discharge Rate Ratio

Discharge rate ratio (%)=[(Discharge capacity at 3.0 It/Discharge capacity at 1.0 It)]×100 Eq. (2)

TABLE 2

| | | Average particle size | | | | | |
|---|---|---|---|---|---|---|---|
| | | and amount of silica | | | | | |
| | | Average | | | Remaining capacity ratio | | |
| | Inorganic | particle | Amount | Addition | Discharged | Discharged | Discharge |
| Battery | particle | size (nm) | (mass %) | of CMC | at 1.0 It | at 0.2 It | rate ratio |
| A1 | TiO₂ | 40 | 10 | No | 85% | 91% | 37% |
| A2 | | | 1 | No | 85% | 90% | 38% |
| A3 | | | 5 | No | 86% | 91% | 38% |
| A4 | | | 20 | No | 83% | 89% | 31% |
| A5 | | 20 | 10 | No | 84% | 90% | 37% |
| A6 | | 16 | 10 | No | 85% | 91% | 38% |
| A7 | Al₂O₃ | 40 | 10 | No | 86% | 91% | 39% |
| Z1 | TiO₂ | — | — | — | 65% | 68% | 38% |
| Z3 | | — | — | Yes | 83% | 88% | 37% |
| Z4 | | 40 | 10 | Yes | 82% | 87% | 38% |

### High-Temperature Storage Performance

The batteries A1 to A7, Z3, and Z4, which had a porous layer on the positive electrode surface, exhibited higher remaining capacity ratios than that of the battery Z1, which had no porous layer, irrespective of the discharge current values. This demonstrates that the high-temperature storage performance was improved for the batteries A1 to A7, Z3, and Z4. Among the batteries A1 to A7, Z3, and Z4, the battery Z4, which contained silica as the dispersing agent in addition to CMC, showed almost the same as or a slightly lower remaining capacity ratio than the battery Z3, which contained CMC alone as the dispersing agent. On the other hand, the batteries A1 to A7, which contained silica alone as the dispersing agent, exhibited remaining capacity ratios 1-3% higher than that of the battery Z3. The reason is as follows. When CMC is contained as the dispersing agent, side reactions occur during storage because CMC is an organic dispersing agent. This results in adverse effects on the battery performance. On the other hand, when silica alone is contained as the dispersing agent, no side reaction occurs during storage because silica is an inorganic dispersing agent. As a result, the adverse effects on the battery performance are prevented.

Thus, the batteries Z3 and Z4, in which the porous layer exists on the positive electrode surface, show improved storage performance over the battery Z1, in which the porous layer does not exist on the positive electrode surface. Nevertheless, in the batteries Z3 and Z4, the CMC, which is added as the dispersing agent, is decomposed during storage. It is believed that for that reason, the batteries Z3 and Z4 showed lower storage performance than the batteries A1 to A7, in which the silica added as the dispersing agent is not decomposed during storage.

### High-Rate Capability

Among the batteries A1 to A3, A5 to A7, Z1, Z3, and Z4, no significant difference in discharge rate ratio was observed. However, the battery A4 showed a discharge rate ratio about 6-7% lower than those. The reason is believed to be as follows. In the battery A4, the amount of the silica is greater than those in the batteries A1 to A3 and A5 to A7 (the battery A4 contains silica in an amount of 20 mass %), and thus, the quantity of void in the porous layer is smaller. As a consequence, the electrolyte permeation was lowered, and accordingly, the lithium ion conductivity was lowered.

Taking this into consideration, it is believed that the reason why the battery A4 showed a slightly lower remaining capacity ratio than the batteries A1 to A3 and A5 to A7 is not because the improvement effect obtained by the addition of the silica was little, but rather because the high-rate capability was lowered and consequently the discharge capacity at 1.0 It was reduced.

The above-described results of the experiment indicates that it is preferable that the amount of the silica be restricted to 15 mass % or less, more preferably 10 mass % or less, with respect to the total amount of the inorganic particles and the silica.

It is preferable that the lower limit of the amount of silica be 1 mass % or greater. The reason is that if the amount of silica is less than 1 mass %, the effect of the dispersion stabilization obtained by adding the silica may become insufficient.

### Other Embodiments

(1) Although not shown in the above-described experiments, silica has high affinity with the electrolyte solution and therefore can prevent lowering of the affinity between the positive electrode active material and the electrolyte solution. As a result, there is an additional advantageous effect of inhibiting the electrolyte balance in the battery from being disturbed.

(2) It is necessary that the average particle size of the silica be restricted to less than 100 nm. The reason is that if the particle size is 100 nm or greater, the silica tends to be easily settled because of its own weight, and it does not exhibit the function as the dispersing agent sufficiently.

Theoretically, it is possible that silica can function as the dispersing agent even when the average particle size of the silica is 100 nm or greater. However, in order to ensure sufficient dispersibility with the silica having an average particle size of 100 nm or greater, an organic addition agent becomes necessary additionally. This may result in decomposition of the organic addition agent, which is another problem. Thus, it is necessary that the average particle size of the silica be restricted to less than 100 nm in order to obtain the function of the silica as the dispersing agent and at the same time avoid the problem associated with the decomposition of the addition agent.

In addition, in order to obtain a greater dispersion effect of inorganic particles with a smaller amount of the silica added, the number of the silica particles per unit volume should be greater. Taking this into consideration, it is particularly preferable that the average particle size of the silica be 50 nm or less. However, when the average particle size of the silica is less than 10 nm, the silica particles tend to aggregate easily. For this reason, it is preferable that the average particle size of the silica be 10 nm or greater.

(3) It is preferable that the average particle size of the inorganic particles be restricted to 100 nm or greater. The reason is as follows. When the average particle size of the inorganic particles is less than 100 nm, the inorganic particles are packed densely, so the quantity of void in the porous layer is considerably small. As a consequence, the electrolyte solution does not easily pass through the void (through the inside of the porous layer), and the charge-discharge performance lowers considerably. In other words, because the porous layer does not function properly when the average particle size of the inorganic particles is less than 100 nm, the average particle size of the inorganic particles is restricted to 100 nm or greater. Thus, it is clear that the silica in the present invention that has an average particle size of less than 100 nm functions as a dispersing agent in the porous layer, not as the inorganic particles for forming the void in the porous layer.

(4) It is desirable that the silica have a purity of 99.9% or higher. The reason is as follows. The porous layer is formed on the positive electrode surface and therefore easily affected by the positive electrode potential. This means that when the silica contains impurities such as iron (i.e., when the silica has a purity of less than 99.9%), the impurities are dissolved in the electrolyte solution and thereafter deposited on the negative electrode, and there is a possibility of causing short circuiting in the battery.

(5) For the same reason as stated in the above (4), it is desirable that the inorganic particles be made of alumina having a purity of 99.9% or higher, or titania having a purity 99.9% or higher. Alumina and titania are stable even under an oxidizing atmosphere at high voltage, and moreover, microparticles of alumina and titania with a high purity are easily available.

(6) It is desirable that the silica have been treated by a hydrophilic treatment, as the ones used in the foregoing examples. When the silica is treated with a hydrophilic treatment, siloxane or silanol groups are arranged on the particle surface in a large amount, so these exhibit lubricant function at the time of dispersion. Therefore, the load on the equipment used in pulverization of fine particles is alleviated (that is, the equipment is prevented from being scraped by the silica), and as a result, the silica is prevented from being contaminated with impurities.

It is desirable that the silica have been produced by an ultrafine-particle pyrogenic method and treated by a hydrophilic treatment.

Methods of producing silica generally include a vapor deposition method, a dry method (including a dry grinding method and an ultrafine-particle pyrogenic method), or a wet method. The silica used in the present invention may be produced by any one of the foregoing methods, but it is most desirable to use the one produced by an ultrafine-particle pyrogenic method. The reason is as follows.

It is not common to produce silica by a vapor deposition method, and the vapor deposition method is poor in mass productivity. The silica produced by a wet method contains many pores and thus has too large a surface area, resulting in too large a liquid absorption amount in the dispersion medium. Consequently, the slurry characteristic (viscosity) is difficult to control, so the handleability is poor. Although the silica produced by a dry grinding method is commercially available, it tends to contain impurities, and moreover, it is extremely difficult to pulverize the silica into a particle size smaller than a certain level. In contrast to these, the silica produced by an ultrafine-particle pyrogenic method is easy to control the particle size (i.e., the particle size of the silica can be made small). Furthermore, because the silica is treated with a hydrophilic treatment, the silica is prevented from being contaminated with impurities.

(7) If the thickness of the porous layer is too thin, the advantageous effects obtained by forming the porous layer may be insufficient. On the other hand, if the thickness of the porous layer is too thick, the high-rate capability and the energy density of the battery will be poor. Taking these into consideration, it is preferable that the porous layer have a thickness of 4 μm or less, more preferably within the range of from 0.5 μm to 4 μm, and still more preferably within the range of from 0.5 μm to 2 μm. When the thickness of the porous layer is restricted in this way, it is preferable that the inorganic particles have an average particle size of 1 μm or less, more preferably within the range of from 0.1 μm to 0.6 μm.

(8) As described above, water is used as the solvent for the slurry used in forming the porous layer in order to prevent the energy density from decreasing and to lower the environmental impact. The material of the aqueous binder for the porous layer is not particularly limited, but it is preferable that the material satisfy the following characteristics:

(a) ensuring dispersibility of the inorganic particles (for preventing re-aggregation),

(b) ensuring adhesion capability that enables the inorganic particles to withstand the manufacturing process of the battery,

(c) filling the gaps between the inorganic particles resulting from the expansion after absorbing the non-aqueous electrolyte, and

(d) inhibiting the non-aqueous electrolyte from dissolving away.

In order to ensure sufficient battery performance, it is preferable that the above-described effects can be obtained with a small amount of the aqueous binder. For this reason, it is preferable that the content of the aqueous binder in the porous layer be 30 parts by mass or less, more preferably 10 parts by mass or less, and still more preferably 5 parts by mass, per 100 parts by mass of the porous layer. On the other hand, the lower limit value of the amount of the aqueous binder in the porous layer is generally 0.1 parts by mass or greater per 100 parts by mass of the porous layer.

Preferable examples of the material for the aqueous binder include polytetrafluoroethylene (PTFE), polyacrylonitrile (PAN), styrene-butadiene rubber (SBR), modified substances thereof, derivatives thereof, copolymers containing acrylonitrile units, and polyacrylic acid derivatives. A copolymer containing acrylonitrile units is particularly preferable to obtain the above-listed characteristics (a) and (c) sufficiently with a small amount of the aqueous binder added.

The aqueous binder in the present invention may be used in the form of, for example, emulsion resin or water-soluble resin.

(9) A suitable method for dispersing the slurry is a wet-type dispersion technique such as a technique using a bead mill or a Filmics mixer made by Primix Corp. Since it is preferable that the particle size of the inorganic particles used in the present invention be small, a uniform film cannot be formed unless the dispersion process is conducted mechanically, because settling of the slurry is considerable. For this reason, a dispersion technique used for dispersing paint may be used preferably.

(10) Examples of the method for forming the porous layer on the positive electrode surface include die coating, gravure coating, dip coating, curtain coating, and spray coating. Gravure coating and die coating are especially preferable. When the solvent or the binder diffuses in the electrode, problems arise, such as the lowering of the bonding strength between the porous layer and the positive electrode. For this reason, it is desirable to use a method that is capable of high speed coating and that requires a shorter drying time. Although the solid content in the slurry varies depending on the method of coating, it is preferable that the solid content be low, specifically, within the range of from 3 mass % to 30 mass %, for the spray coating, dip coating, and curtain coating, in which the thickness of coating is difficult to control mechanically. On the other hand, the solid content may be higher for die coating, gravure coating, and the like, and the solid content may be from about 5 mass % to about 70 mass %.

(11) The positive electrode active material used in the present invention may be one having a layered structure. In particular, a lithium-containing transition metal oxide having a layered structure is preferable. Examples of such a lithium-containing transition metal oxide include lithium composite oxides such as lithium cobalt oxide, lithium-nickel-cobalt-manganese composite oxide, lithium-nickel-manganese-aluminum composite oxide, and lithium-nickel-cobalt-aluminum composite oxide. Especially preferable is a positive electrode active material in which the capacity is increased by setting the end-of-charge potential of the positive electrode to be 4.30 V (vs. Li/Li⁺) or higher. These positive electrode active materials may be used either alone or in combination with other positive electrode active materials.

(12) The negative electrode active material used in the present invention is not particularly limited, and any kind of active material may be used as long as it can be used as the negative electrode active material for non-aqueous electrolyte secondary batteries. Examples of the negative electrode active material include carbon materials such as graphite and coke, metal oxides such as tin oxide, metals such as silicon and tin that can absorb lithium by alloying with lithium, and metallic lithium. Carbon materials such as graphite are particularly preferable for the negative electrode active material in the present invention.

(13) In the non-aqueous electrolyte secondary battery of the present invention, it is preferable that the end-of-charge potential of the positive electrode be set to 4.30 V (vs. Li/Li⁺) or higher, more preferably 4.35 V (vs. Li/Li⁺) or higher, and still more preferably 4.40 V (vs. Li/Li⁺) or higher. By setting the end-of-charge potential of the positive electrode higher than that in the conventional cases, the charge-discharge capacity can be increased. Nevertheless, by raising the end-of-charge potential of the positive electrode, the transition metals such as cobalt and manganese tend to dissolve away more easily from the positive electrode active material. However, according to the present invention, the cobalt and manganese that have dissolved away are trapped by the porous layer, so the dissolved substances are prevented from depositing on the negative electrode surface. As a result, the high-temperature storage performance can be prevented from degrading.

When a carbon material is used as the negative electrode active material, the end-of-charge potential of the negative electrode is about 0.1 V (vs. Li/Li⁺). Accordingly, when the end-of-charge potential of the positive electrode is 4.30 V (vs. Li/Li⁺), the end-of-charge voltage is 4.20 V. When the end-of-charge potential of the positive electrode is 4.35 V (vs. Li/Li⁺), the end-of-charge voltage is 4.25 V. When the end-of-charge potential of the positive electrode is 4.40 V (vs. Li/Li⁺), the end-of-charge voltage is 4.30 V. When the end-of-charge potential of the positive electrode is 4.50 V (vs. Li/Li⁻), the end-of-charge voltage is 4.40 V.

(14) The non-aqueous electrolyte secondary battery of the present invention has excellent high-temperature storage performance. For example, when the invention is applied to a non-aqueous electrolyte secondary battery that is operated in an environment at 50° C. or higher, the advantageous effects of the invention can be exhibited significantly.

(15) The solvent for the non-aqueous electrolyte used in the present invention may be any solvent that has conventionally been used as a solvent for an electrolyte in non-aqueous electrolyte secondary batteries. Particularly preferable example is a mixed solvent of a cyclic carbonate and a chain carbonate. More specifically, it is preferable that the mixing ratio of the cyclic carbonate and the chain carbonate be set within the range of 1:9 to 5:5 (cyclic carbonate : chain carbonate). Examples of the cyclic carbonate include ethylene carbonate, propylene carbonate, butylene carbonate, and vinylene carbonate. Examples of the chain carbonate include dimethyl carbonate, methyl ethyl carbonate, and diethyl carbonate.

There is no limitation to the electrolyte of the non-aqueous electrolyte secondary battery, and any type of electrolyte may be used as long as the lithium compound used as the solute for providing ionic conductivity and the solvent used for dissolving and retaining the solute are not decomposed at a voltage during charge and discharge or at a voltage during the storage of the battery. Examples of the solute of the non-aqueous electrolyte used in the present invention include LiPF₆, LiBF₄, LiCF₃SO₃, LiN(CF₃SO₂)₂, LiN(C₂F₅SO₂)₂, LiC(CF₃SO₂)₃, LiC(C₂F₅SO₂)₃, and mixtures thereof.

It is also possible to use, as the electrolyte, a gelled polymer electrolyte in which an electrolyte solution is impregnated in a polymer electrolyte such as polyethylene oxide and polyacrylonitrile, and an inorganic solid electrolyte such as LiI or Li₃N.

(16) In the present invention, it is preferable that the ratio of the negative electrode charge capacity to the positive electrode charge capacity (negative electrode charge capacity/positive electrode charge capacity, hereinafter also referred to simply as the “charge capacity ratio”) be restricted to be within the range of from 1.0 to 1.1. Setting the charge capacity ratio to be 1.0 or greater serves to prevent deposition of metallic lithium on the negative electrode surface and thereby improve the cycle performance and reliability of the battery. However, if the charge capacity ratio exceeds 1.1, the energy density per volume may undesirably decrease. It should be noted that the charge capacity ratio is set corresponding to the end-of-charge voltage of the battery.

The non-aqueous electrolyte secondary battery of present invention can be used for driving power sources for mobile information terminals such as mobile telephones, notebook computers, and PDAs, especially for use in applications that require a high capacity. The non-aqueous electrolyte secondary battery of the invention is also applicable to high power applications that require continuous operations under high temperature conditions, such as HEVs and power tools, in which the battery operates under severe operating environments.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A non-aqueous electrolyte secondary battery comprising:
a positive electrode containing a positive electrode active material;
a porous layer, provided on a surface of the positive electrode, comprising inorganic particles, a dispersing agent, and an aqueous binder, the dispersing agent comprising silica having an average particle size of less than 100 nm and less than that of the inorganic particles;
a negative electrode containing a negative electrode active material;
a separator interposed between the positive electrode and the negative electrode; and
a non-aqueous electrolyte containing a solvent and a solute.

2. The non-aqueous electrolyte secondary battery according to claim 1, wherein the silica has a purity of 99.9% or higher.

3. The non-aqueous electrolyte secondary battery according to claim 1, wherein the amount of the silica is from 1 mass % to 15 mass % with respect to the total amount of the inorganic particles and the silica.

4. The non-aqueous electrolyte secondary battery according to claim 2, wherein the amount of the silica is from 1 mass % to 15 mass % with respect to the total amount of the inorganic particles and the silica.

5. The non-aqueous electrolyte secondary battery according to claim 1, wherein the inorganic particles are made of alumina having a purity of 99.9% or higher, or titania having a purity of 99.9% or higher.

6. The non-aqueous electrolyte secondary battery according to claim 1, wherein the silica has been treated by a hydrophilic treatment.

7. The non-aqueous electrolyte secondary battery according to claim 2, wherein the silica has been treated by a hydrophilic treatment.

8. The non-aqueous electrolyte secondary battery according to claim 3, wherein the silica has been treated by a hydrophilic treatment.

9. The non-aqueous electrolyte secondary battery according to claim 4, wherein the silica has been treated by a hydrophilic treatment.

10. The non-aqueous electrolyte secondary battery according to claim 5, wherein the silica has been treated by a hydrophilic treatment.

11. The non-aqueous electrolyte secondary battery according to claim 1, wherein the silica has been produced by an ultrafine-particle pyrogenic method and treated by a hydrophilic treatment.

12. The non-aqueous electrolyte secondary battery according to claim 2, wherein the silica has been produced by an ultrafine-particle pyrogenic method and treated by a hydrophilic treatment.

13. The non-aqueous electrolyte secondary battery according to claim 3, wherein the silica has been produced by an ultrafine-particle pyrogenic method and treated by a hydrophilic treatment.

14. The non-aqueous electrolyte secondary battery according to claim 4, wherein the silica has been produced by an ultrafine-particle pyrogenic method and treated by a hydrophilic treatment.

15. The non-aqueous electrolyte secondary battery according to claim 5, wherein the silica has been produced by an ultrafine-particle pyrogenic method and treated by a hydrophilic treatment.
